(19) United States
(12) Patent Application Publication
(10) Pub. No.: US 2015/0019735 A1
(43) Pub. Date: Jan. 15, 2015

(54) HOSTER INTERFACE FOR MANAGING AND ADDING SERVICES

(71) Applicant: Microsoft Corporation, Redmond, WA (US)

(72) Inventors: Vladimir Gregory Pogrebinsky, Sammamish, WA (US); Sata Busayarat, Redmond, WA (US); Jameel Adedayo Gbajabiamila, Bellevue, WA (US); Bradley John Bartz, Woodinville, WA (US); William James Staples, Duvall, WA (US)

(21) Appl. No.: 14/315,094

(22) Filed: Jun. 25, 2014

Related U.S. Application Data
(60) Provisional application No. 61/844,356, filed on Jul. 9, 2013.

(51) Int. Cl. H04L 12/24

(52) U.S. Cl. CPC H04L 41/5041
USPC 709/226

(57) ABSTRACT

An application program interface through which a hoster of a cloud computing environment may facilitate (e.g., create, provision and/or manage) services in their cloud computing environment. Also, a user interface that is configurable to interface with different cloud computing environments that have different hosters. For instance, once cloud computing environment might be a private cloud and the other a public cloud. Yet, the user interface permits a user to interface with each cloud computing environment in a consistent way.

### CROSS REFERENCE TO RELATED APPLICATIONS

This application claims the benefit of U.S. Provisional Application Ser. No. 61/844,356, filed Jul. 9, 2013, which provisional patent application is incorporated herein by reference in its entirety.

### BACKGROUND

Cloud computing enables uses to access a wide variety of computing services in a manner that is often independent of location. From the user's perspective, it is as though the user is able to pull those services out of the ever present cloud above them. In order to enable this appearance, data centers provide the hardware backing using large numbers of servers.

The data center may provide any level of services including Infrastructure as a Service (IAAS), Platform As A Service (PAAS), Software As A Service (SAAS), or any other level of service. In IAAS, the data center essentially just provides its hardware (e.g., memory, storage, network, processing) in appropriate amounts for each client. At the other end of the spectrum, in SAAS, all processing is essentially performed at the data center without rendering instructions and user input passing over the network. Accordingly, even a thin client can engage in rich services. The data center may provide any level of service in-between these two extremes.

Each data center has an owner (also called a hoster) that provides services to one or more clients that make requests into the data center. A data center may be a private or enterprise data center, in which usually the clients are limited to a particular organization. A data center might also be a public data center, which serves subscribing customers throughout the globe. Of course, such public data centers may be quite large, and the hoster may have multiple intercommunicating data centers. Hoster data centers are somewhere in between, as they can server multiple tenants, but tend not to be specific to a particular enterprise, nor do they tend to provide global service.

The subject matter claimed herein is not limited to embodiments that solve any disadvantages or that operate only in environments such as those described above. Rather, this background is only provided to illustrate one exemplary technology area where some embodiments described herein may be practiced.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a public cloud architecture in which a management portal/API allow entities to communicate with the public cloud architecture;

FIG. 2 illustrates an environment that extends across multiple clouds;

FIG. 3 illustrates an example user interface that might appear to an authorized user of a tenant, after the user logs onto the management portal;

FIG. 4 illustrates a user interface in which the tenant is provided with the option of subscribing to additional plans, thereby augmenting the subscription set corresponding to the tenant;

FIG. 5 illustrates a user interface in which the tenant is presented with information associated with a provisioned virtual machine;

FIG. 6 illustrates an example of the relationship between administrators of service providers and tenants;

FIG. 7 illustrates an example user interface showing a view provided to an administrator regarding a particular plan;

FIG. 8 illustrates an example user interface showing a view provided to an administrator regarding the various tenants (called “users” in the diagram”);

FIG. 9 illustrates an example user interface showing a view provided to an administrator regarding the web site cloud services;

FIG. 10 illustrates a user interface in which the administrator is shown a histogram of CPU and memory usage consumed by the service, as well as other status information such as status, number of web workers, number of front ends, and the number of publishing servers associated with the service;

FIG. 11 illustrates a user interface in which the administrator is shown the roles associated with the service, as well as the status, role, type, number of sites, the CPU utilization percentage, and memory usage percentage associated with each role of the service;

FIG. 12 illustrates a user interface in which the administrator is shown the web sites associated with the service, as well as the status, owner, number of workers, and subscription identifier associated with each web site of the service;

FIG. 13 illustrates an example user interface showing a view provided to an administrator regarding the virtual machine cloud services;

FIG. 14 illustrates an example user interface showing a view provided to an administrator regarding database server cloud services;

FIG. 15 illustrates various plans offered by the service provider;

FIG. 16 illustrates a user interface provided to an administrator after narrowing in on one of the plans illustrated in FIG. 15;

FIG. 17 illustrates a user interface showing an administrator various parameters relative to one of the services, the web site cloud;

FIG. 18 illustrates an environment in which there are 3 stamps and 3 VMM servers;

FIG. 19 illustrates service bus queues that represent one solution that might be offered by a service bus service; and

FIG. 20 illustrates service bus topics that represent another solution that might be offered by a service bus service.

### SUMMARY

At least some embodiments described herein provide for an application program interface through which a hoster of a cloud computing environment may facilitate (e.g., create, provision and/or manage) services in their cloud computing environment. At least some embodiment described herein also relate to a user interface that is configurable to interface with different cloud computing environments that have different hosters. For instance, once cloud computing environment might be a private cloud and the other a public cloud. Yet, the user interface permits a user to interface with each cloud computing environment in a consistent way.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DETAILED DESCRIPTION

At least some embodiments described herein relate to an application program interface through which a hoster of a cloud computing environment may facilitate (e.g., create, provision and/or manage) services in their cloud computing environment. At least some embodiment described herein also relate to a management portal that may be used to interface with different types of data centers in a consistent way using a set of common Application Program Interfaces (APIs) and/or a common user interface. For instance, the management portal may be used to interface using the common interface with data centers having different hosters that actual provide and run the data center.

An enterprise data center is limited to a single organization and is often formulated using equipment belonging to that single organization. In other words, the tenant (the organization that consumes the services of the data center) is the same as the hoster (the organization providing the data center). Such enterprise data centers are often referred to as “on-premises” data centers as they are often located on the premises of the single organization often at a single location. Such enterprise data centers are also referred to as a “private cloud”, since the cloud has but a single tenant, which is the hoster of the data center.

A public data center is a collection of one or more data centers that has a larger number of tenants. The data center keeps the data belonging to each tenant secure and separate. Public data centers are often distributed throughout the globe and are often referred to as a “public cloud”. The cloud is “public” in the sense that as long as legally possible, just about any organization or individual can subscribe to services of the public cloud. Hosters of public clouds presently include MICROSOFT® Corporation, GOOGLE® Inc., and AMAZON.COM®, Inc., but other large entities with sufficient resources might also host public clouds in the future.

A hoster data center (also called a “hoster cloud”) is a smaller cluster of one or more data centers that serve multiple tenants, but a more limited number of tenants than a public data center.

In this description, there are three tiers of clouds described including a private cloud, a hoster cloud, and a public cloud, listed in order of increasing numbers of tenants. However, the principles described herein may apply to any type of cloud, regardless of whether the cloud or cloud type currently exists, or is yet to be developed. For instance, perhaps in the future, there might be five tiers of clouds including (listed from smallest to largest number of tenants), a private cloud, a smaller hoster cloud, a medium hoster cloud, a larger hoster cloud, and a public cloud. The principles described herein are not limited to the three tiers of clouds, but may apply to any tier structure of clouds through which interfacing is possible using a common interface.

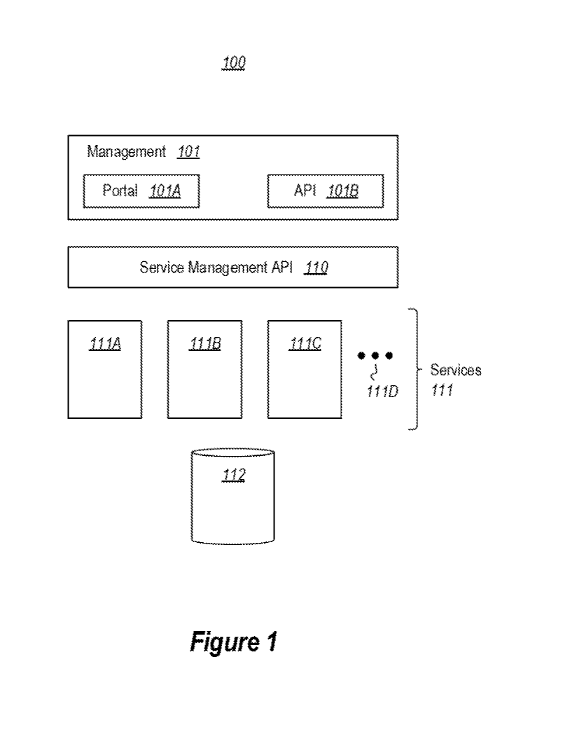

The management portal may be used to interface with any of these data centers in a consistent way using a common set of Application Program Interfaces. For instance, FIG. 1 illustrates a public cloud architecture 100 in which a management portal/API 101 allow entities to communicate with the public cloud architecture. For instance, the management portal/API 101 might be the developer portal in the case of the cloud operating system being WINDOWS AZURE™. The management portal 101A portion of the management portal/API 101 might be a user interface portion, whereas the management API 101B portion of the management portal/API 101 might be an application program interface through which individuals or entities might communicate with the architecture 100.

The management portal/API 101 may include a self-service interface that subscribers use to provision and manage services 111 offered by the public cloud. For instance, the architecture 100 is illustrated as offering three services 111A, 111B and 111C, although the ellipses 111D represent that the public cloud may offer any number of services 111 ranging from as few as one, to potentially many. A hoster administrator may use the management portal/API 101 to create, provision, and manage the various services offered by the cloud, as demonstrated by the various portal user interface examples shown below.

Underlying the management portal/API 101 is service management API 110. In one embodiment, this might be an OData Rest API. The service management API 110 provides access to the underlying services 111 and enables automation of the management portal/API 101. The service management API 110 also enables replacement of the supplied management portal/API 101, opening up the possibility of integrating the services 111 with other management portals (not shown) via the service management API 110. The service management API 110 may be an extensible REST-based API that enables enterprises and hoster cloud providers to integrate their existing systems and tools (e.g. customer portals at the hoster cloud provider) with these new services. In some embodiments, the service management API 110 allows integration with an underlying database 112 that supports the services 111.

In one example, the service 111A is a web site service that provides a multi-tenant web hosting service. The web site service might also support a broad range of programming languages and template web applications. The web site service might also support integration with developer tools and source control repositories. The web site service may enable high density and secure web hosting offerings for hoster cloud providers and enterprises. The hoster administrator may use the management portal/API 101 to add, provision, and manage this web site service.

The service 111B might be, for example, a virtual machine service that enables self-service provisioning of Infrastructure-as-a-Service (also known as IaaS) capabilities enabling a high quality self-service experience to provision and manage Virtual Machines (VMs). This is equivalent to renting a virtual server on which the tenant can install their own operating system and administer the server themselves. The virtual machine service may include a standardized virtual machine gallery for consistent workload deployment and hosting. For instance, the gallery of virtual machines might include virtual machine templates for single virtual machines, and multiple virtual machine groups. Thus, uniform IaaS services may be provided across these contexts, including consistent virtual machine lifecycle management from a provisioning and operations standpoint. The hoster administrator might likewise use the management portal/API 101 to add, provision, and manage this virtual machine service.

The service 111C might be, for example, a service bus service that enables messages to be passed between applications where a synchronous hand-off is not possible but the sender still wants assurance that the message will reach the recipient eventually. Applications may be within the same cloud, across clouds, between clouds and devices, and many other scenarios. The hoster administrator might likewise use the management portal/API 101 to add, provision, and manage this web site service.

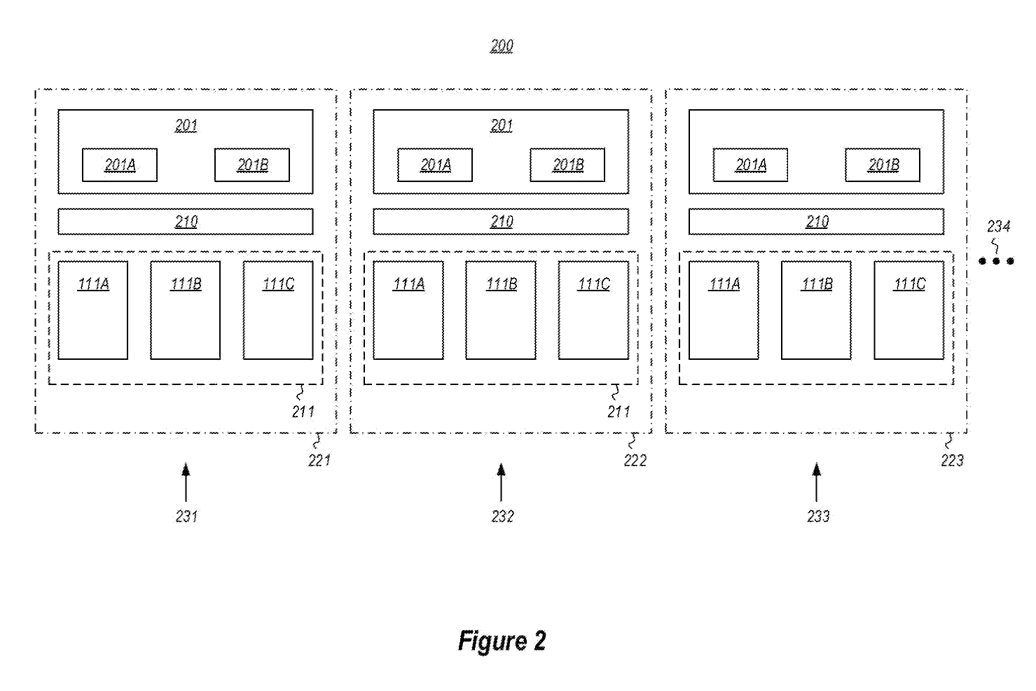

FIG. 2 illustrates an environment 200 that extends across multiple clouds. The environment includes three clouds 231, 232 and 233. Each cloud comprises one of more data centers that are provided by a distinct hoster. As an example only, the cloud 231 might be a private cloud having a single enterprise as the tenant and host, the cloud 233 might be a public cloud having numerous tenants and a public cloud hoster (such as Microsoft, Google, or Amazon), and the cloud 232 might be a hoster cloud having a more limited number of tenants. The ellipses 234 represents that there might be other numbers of data centers in the environment 200 also.

The environment 200 provides parity of application owner experiences irrespective of where the underlying infrastructure resides and what entity is hosting the underlying infrastructure: whether on premises in a private cloud, whether in a hosted environment in a hosted cloud, or whether on a public cloud. This is enabled by providing a management portal/API 201 that is includes at least a subset of the functionality that is the same throughout each of the clouds 231, 232 and 233. This is possible even though at least one of the clouds might have a different operating system than the others.

For instance, cloud 231 may be a private cloud and thus use an operating system 221 that is suitable for a private cloud. Cloud 232 might be a hoster cloud and thus use an operating system 222 that is suitable for a hoster cloud. Cloud 233 might be a public cloud and thus use an operating system 223 that is suitable for a public cloud. Examples of an operating system that is suitable for private and hoster clouds is WINDOWS SERVER SYSTEM® Center, although others suitable operating systems exist in the market. Examples of an operating system that is suitable for a public cloud includes Windows Azure, although again other suitable operating systems, such as Amazon Web Service, also exist on the market.

In any case, regardless of the operating system 221, 222 and 223, the operating system runs a similar management portal 201A and a similar management API 201B. In addition, the operating systems each run a service management API that allows that management portal/API 201 to be automated or replaced by other management portals. Each operating system also hosts a same set of services 211, including service 211A, service 211B and service 211C. Each of the elements 201, 201A, 201B, 210, 211, 211A, 211B and 211C of FIG. 2 may each be instances of the respective elements 101, 101A, 101B, 110, 111, 111A, 111B and 111C of FIG. 1. Accordingly, the management portal/API 201 may use environments having different operating systems without impacting the experience of those user or entities working with the management portal/API 201.

That said, the operating systems 221, 222 and 223 only show the features that are common amongst the different clouds 231, 232 and 233, respectively. That is not to say that the operating systems 221, 222 and 223 may not offer additional functions and features beyond that illustrated. Thus, the operating systems 221, 222 and 223 need not have exactly the same functionality, but they do provide a common user experience and portal. The tenant, who is the user that subscribes to the services and infrastructure of the cloud, thus has uniform self-service and management experiences regardless of whether the cloud is a private cloud, a hoster cloud, or a public cloud, or combinations thereof, and regardless of the hoster that provides the underlying hardware that supports the cloud. In addition, by bringing consistency to the management portal 201A and management API 201B, regardless of the tenancy set of the cloud, service providers may consistently administer services (such as web site services, virtual machine services, and communication bus services) while also offering their customers the rich, self-service user experience to provision and manage their services (such as the tenants' Web sites and virtual machines). In one embodiment, the management portal/API 201 is built on a REST-based Service Management API, and thus these portal experiences are customizable and extensible including possibilities such as partner branding, billing integration and incorporation of incremental solutions and scenarios as well as integrating into existing portals. Each of some of the components of the architecture 200 will now be described in further detail beginning with the management portal 201A.

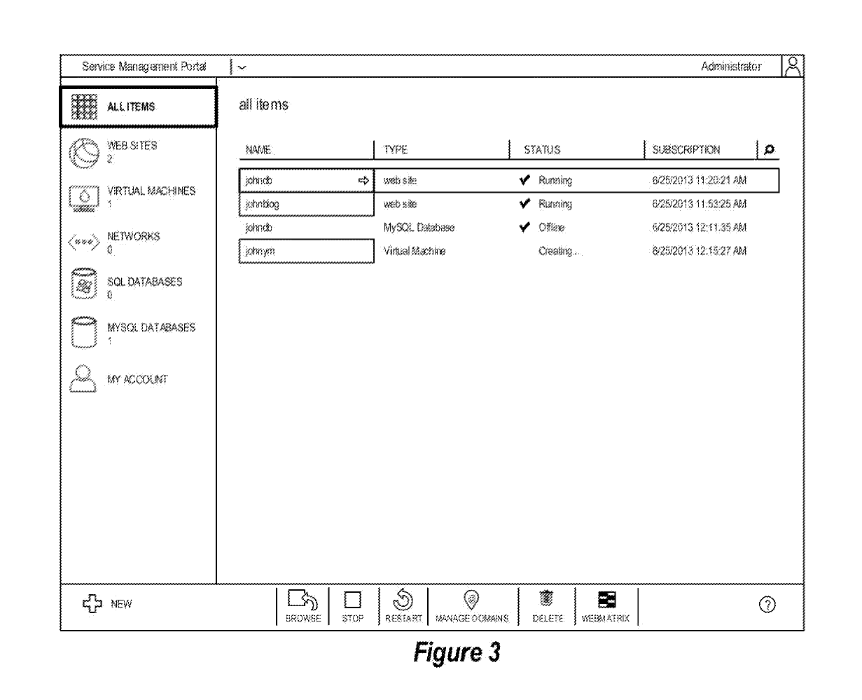

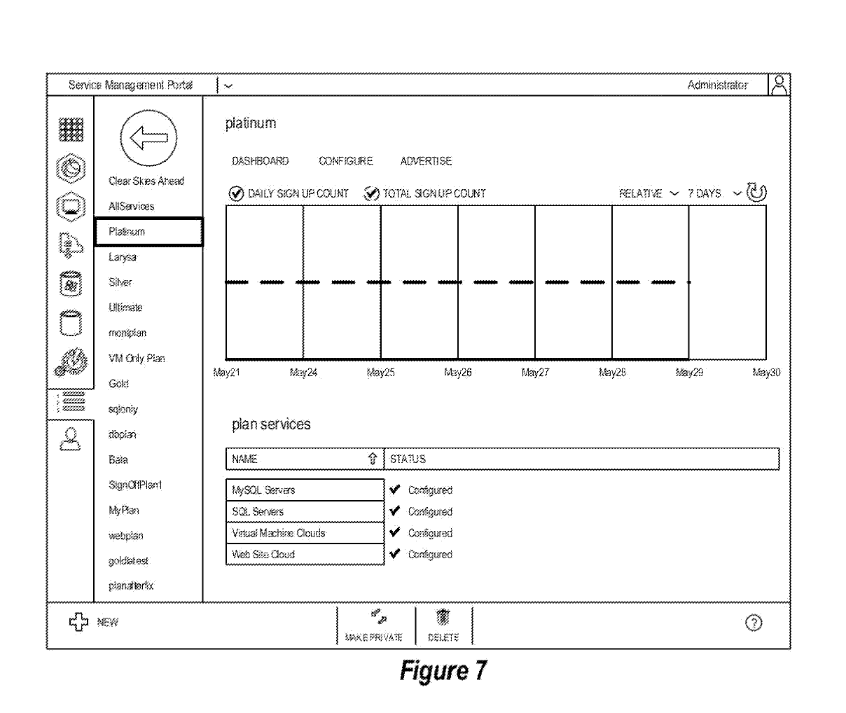

FIG. 3 and many subsequent figures illustrate a series of user interfaces that represent collectively one example of a management portal 201A that may be consistent regardless of the hoster of the underlying cloud. The management portal 201A includes features that are directed towards the tenant that is subscribing to the underlying services and infrastructure, as well as the administrators of the service providers. In particular, FIGS. 3 through 5 illustrate example user interfaces showing portions of the example management portal that are useful for the tenant or host administrator. FIGS. 7 through 17 show portions of the example management portal that are useful for the administrator of the service provider.

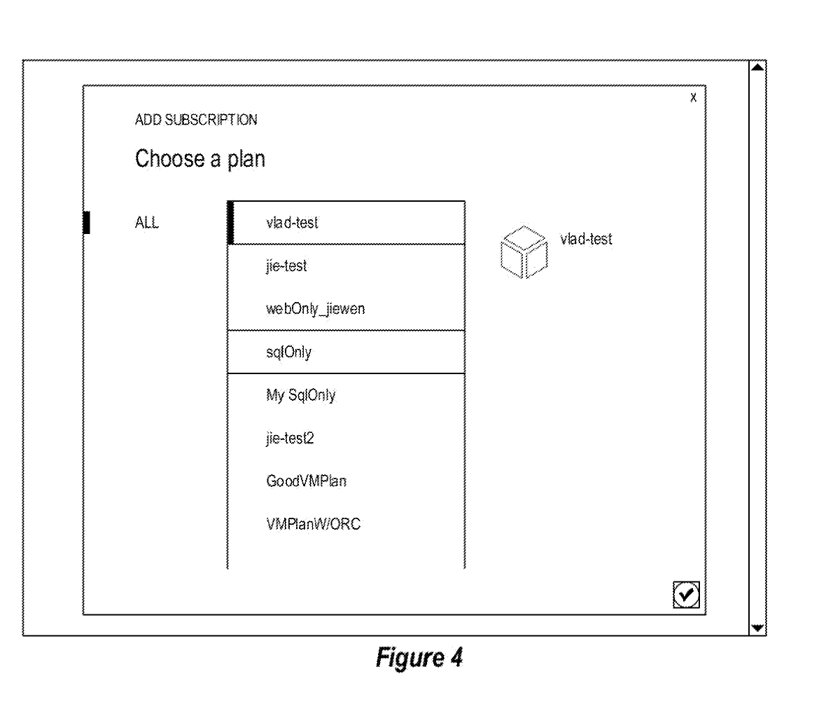

FIG. 3 illustrates an example user interface that might appear to an authorized user of a tenant, after the user logs onto the management portal 201A. Here, the user is provided with a listed of named services to which the tenant has access to via one or more subscriptions. The user interface also shows the type of the service, the status of the service, and also the status of the subscription. For instance, if the subscription that supports the service is going to expire soon, that notification might be present within the subscription column. FIG. 4 illustrates a user interface in which the tenant is provided with the option of subscribing to additional plans, thereby augmenting the subscription set corresponding to the tenant. The exact form of the user interface is not important so much as the uniformity of the user interface regardless of the underlying cloud. For instance, since the management portal 201A is the same regardless of the underlying cloud 231, 232 and 233, the user experience in the management portal may be the same. The management portal may even consolidate all of the services for all of the clouds to which the tenant may access services.

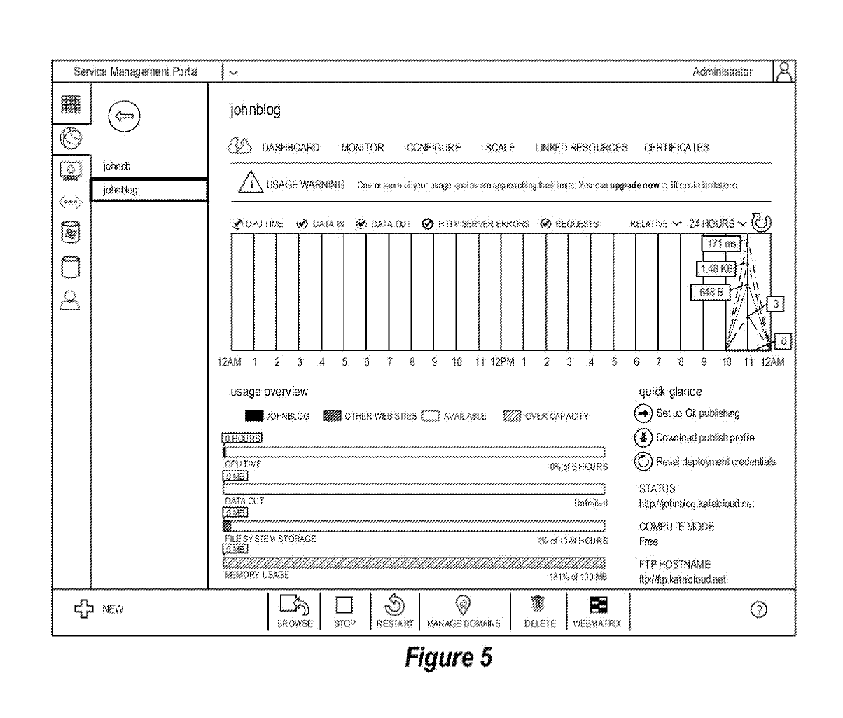

Once the service has been provisioned, the tenant has a rich set of information to help them manage the environment. For instance, FIG. 5 illustrates a user interface in which the tenant is presented with information associated with a provisioned virtual machine. For instance, the user is provided with a histogram showing various performance parameters of the virtual machine including CPU time, input data, output data, server errors, and requests. An overview of the resource usage with respect to total subscription is also provided. For instance, the user may view the tenants CPU time, output data, file system storage, and memory usage with respect to the subscriptions available. The user interface may also be used to start, stop, or pause the service (e.g., the virtual machine).

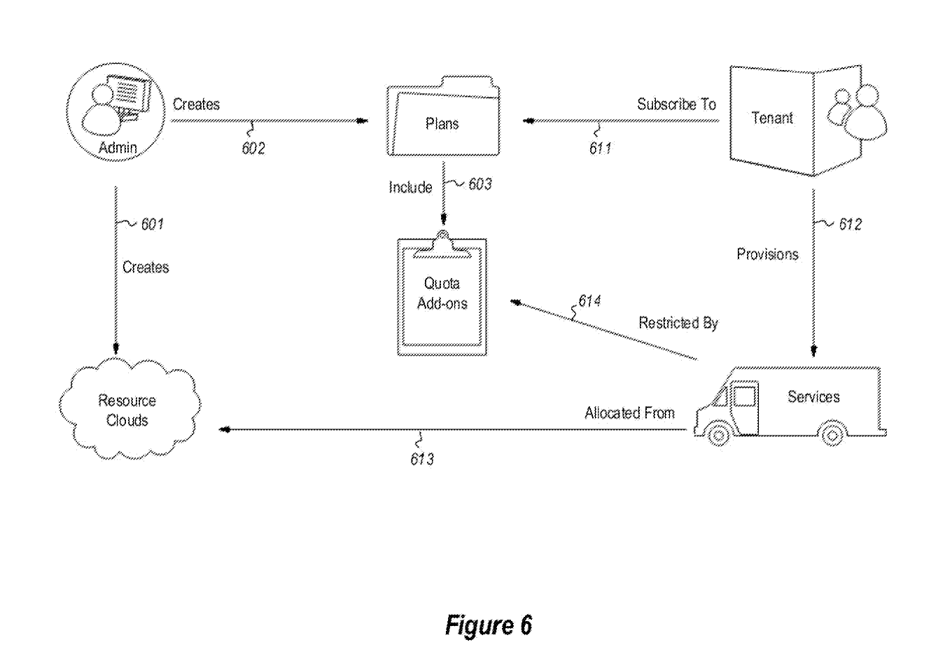

The management portal 201 also has a portal experience that enables administrators to configure and manage the services and resources that are made available to tenants. FIG. 6 illustrates an example of the relationship between administrators of service providers and tenants. Administrators may start by creating resource clouds (as represented by arrow 601) that harness the raw compute, network and storage resources in the datacenter and support the finished services such as web sites, databases and virtual machines. Combinations of these services are added to plans (as represented by arrow 602) along with usage quotas and add-ons (as represented by arrow 603), allowing tenant controlled incremental quotas to increase.

Tenants subscribe to a plan to start using services as represented by arrow 611. FIG. 4 illustrates the example user interface that the tenant may use to accomplish this. Once subscribed to a plan, the tenant is able to provision services (as represented by arrow 612) against a resource cloud (as represented by arrow 613) based on the quota and add-ons (as represented by arrow 614) for that cloud defined in the plan.

FIG. 7 illustrates an example user interface showing a view provided to an administrator regarding a particular plan. The user interface shows the number of new subscriptions to the plan on any given day, as well as the total number of subscriptions to that account on that given day.

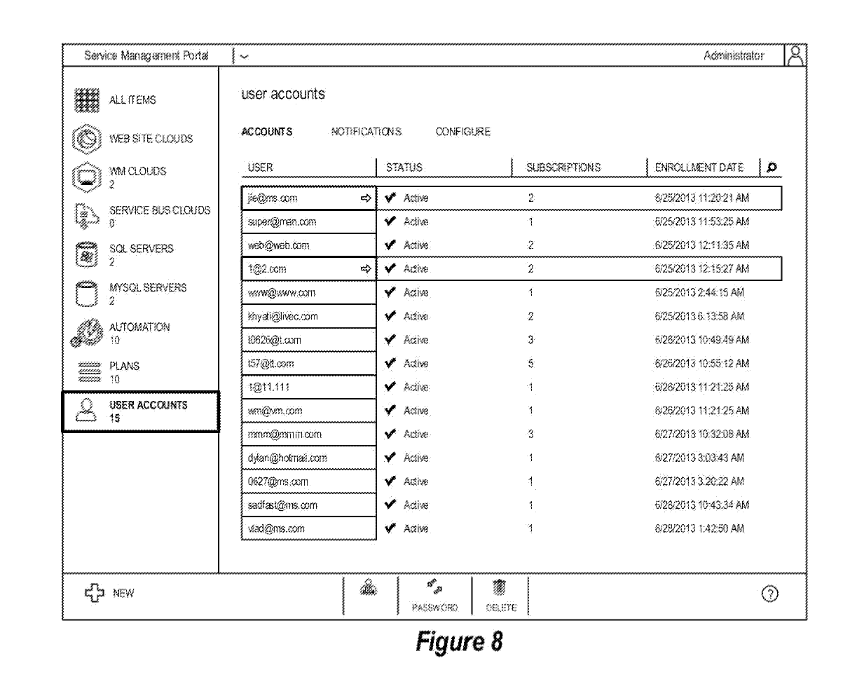

FIG. 8 illustrates an example user interface showing a view provided to an administrator regarding the various tenants (called “users” in the diagram”). The status of each tenant is listed, along with the number of subscriptions and the enrollment date.

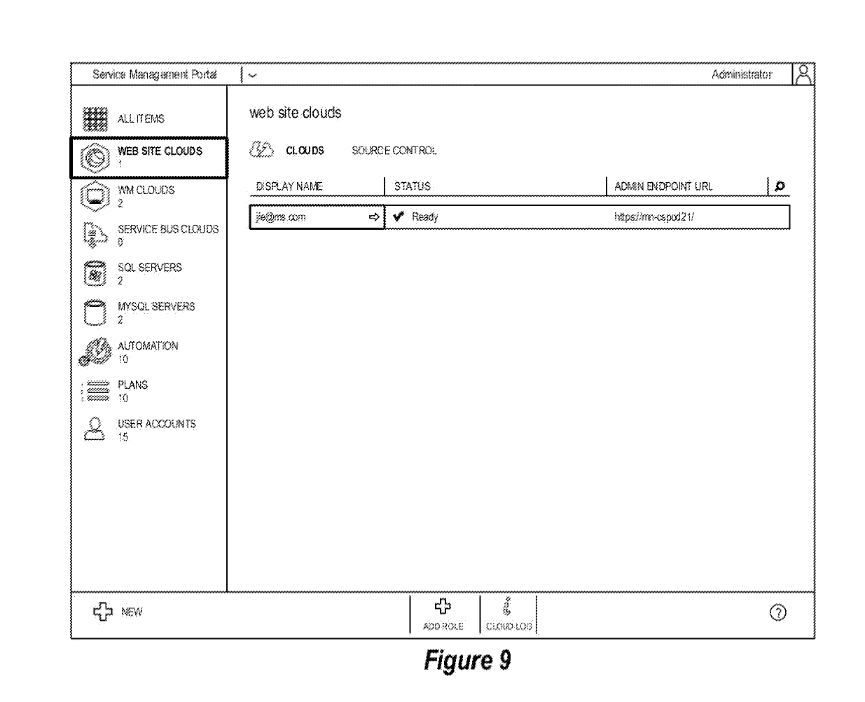

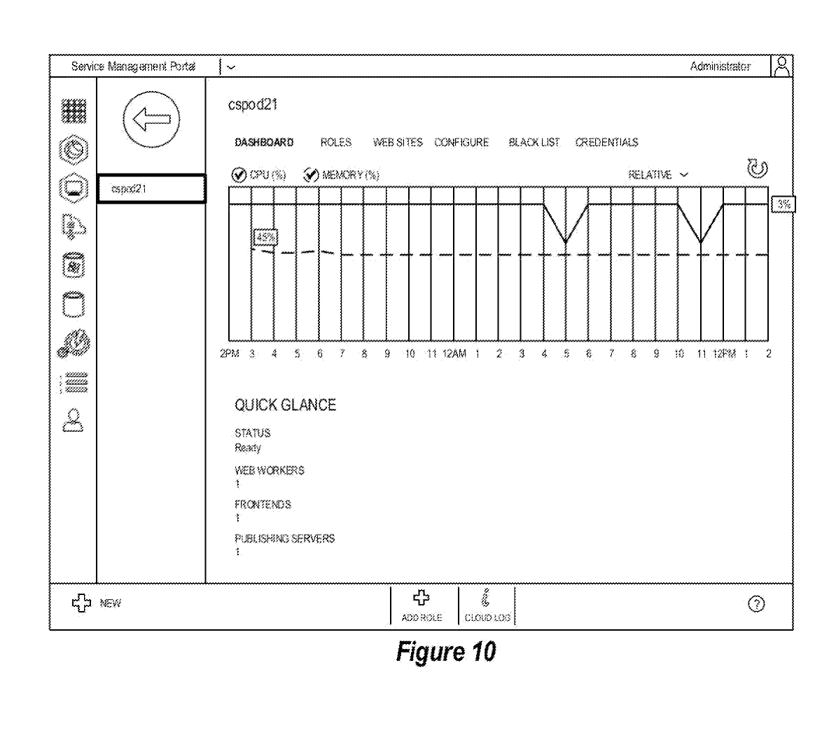

FIG. 9 illustrates an example user interface showing a view provided to an administrator regarding the web site cloud services. Here there is but one web site cloud service shown, along with its status, and administer endpoint URL. FIGS. 10 through 12 show various user interfaces that allow the user to search and further configure the service.

For instance, FIG. 10 illustrates a user interface in which the administrator is shown a histogram of CPU and memory usage consumed by the service, as well as other status information such as status, number of web workers, number of front ends, and the number of publishing servers associated with the service.

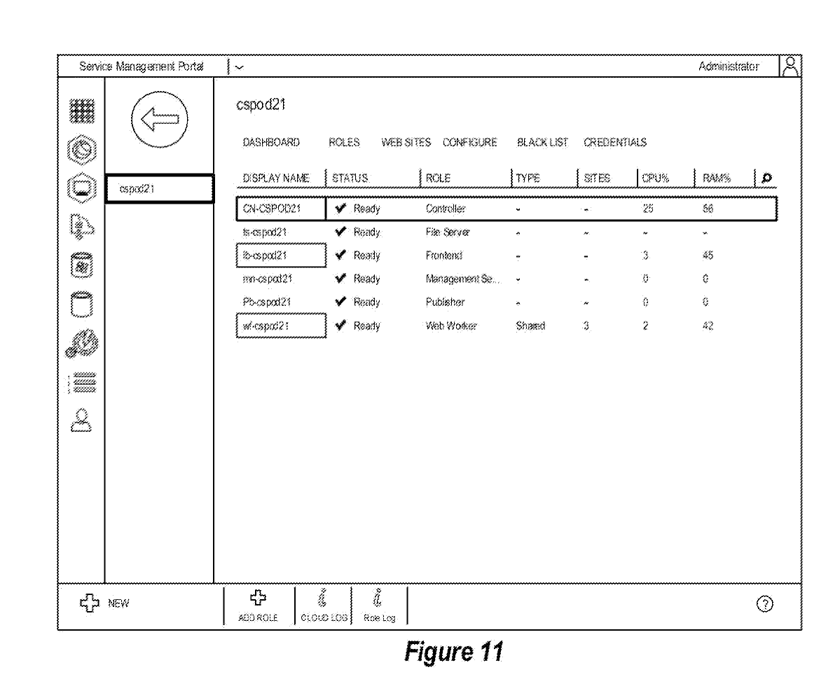

FIG. 11 illustrates a user interface in which the administrator is shown the roles associated with the service, as well as the status, role, type, number of sites, the CPU utilization percentage, and memory usage percentage associated with each role of the service.

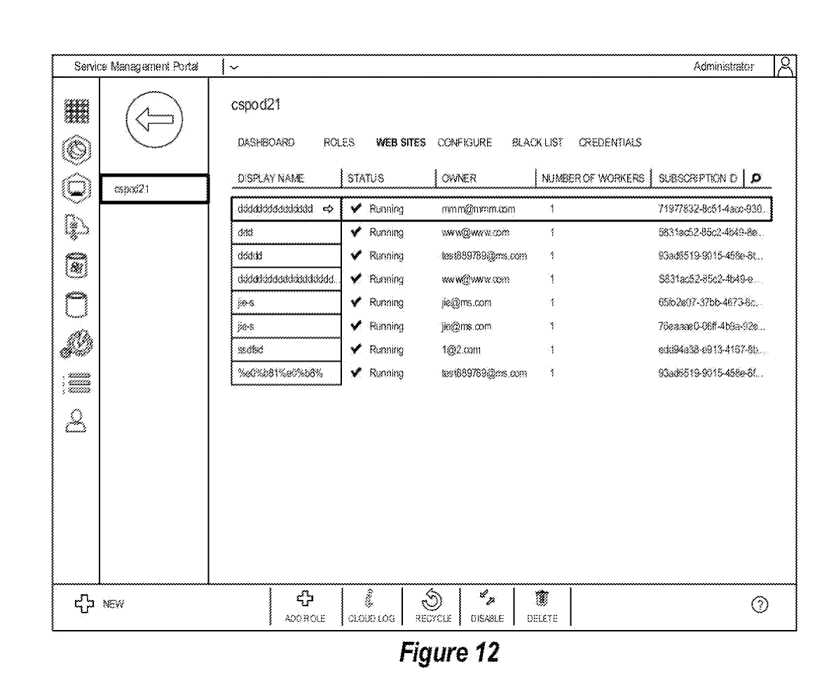

FIG. 12 illustrates a user interface in which the administrator is shown the web sites associated with the service, as well as the status, owner, number of workers, and subscription identifier associated with each web site of the service.

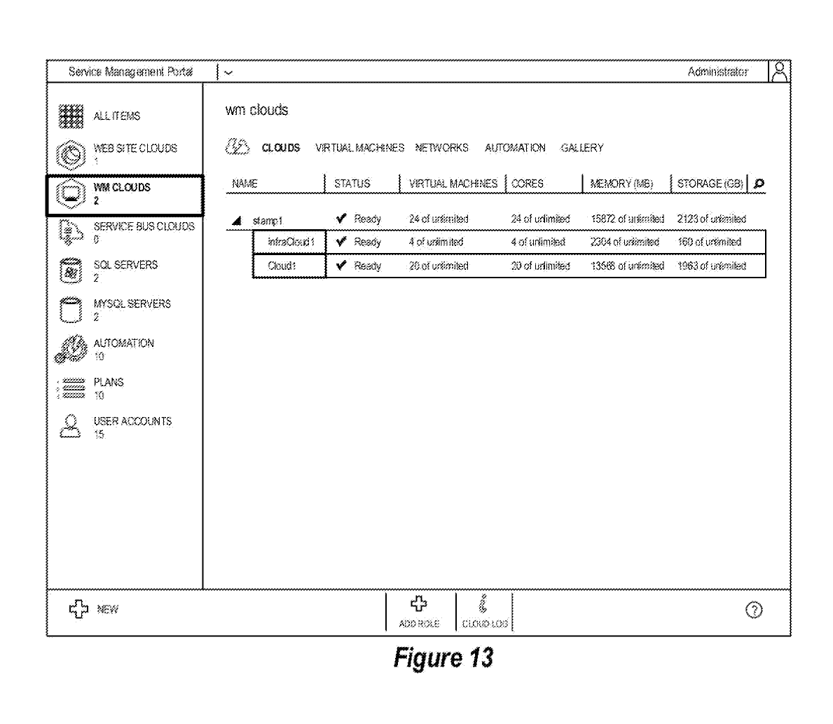

FIG. 13 illustrates an example user interface showing a view provided to an administrator regarding the virtual machine cloud services. Here there is but one web virtual machine cloud service shown, along with its status, number of virtual machines, number of cores, the amount of memory usage, and the amount of storage usage. However, the virtual machine cloud service has two constituent virtual machine cloud services, and the same data is shown with respect to those constituent virtual machine cloud services.

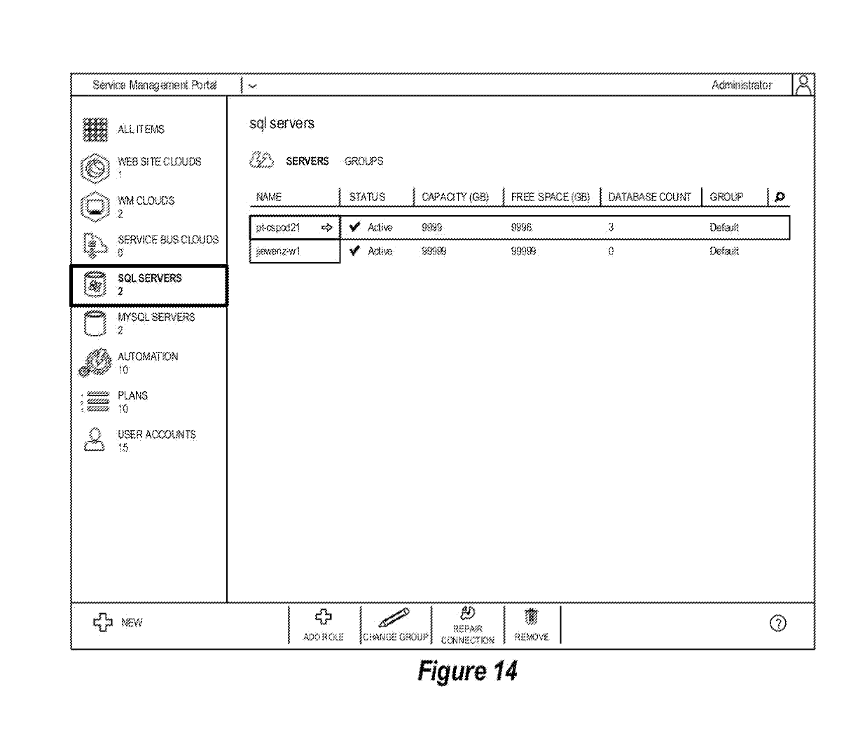

FIG. 14 illustrates an example user interface showing a view provided to an administrator regarding database server cloud services. There are two database server cloud services shown, along with its status, capacity, free space, database count and group.

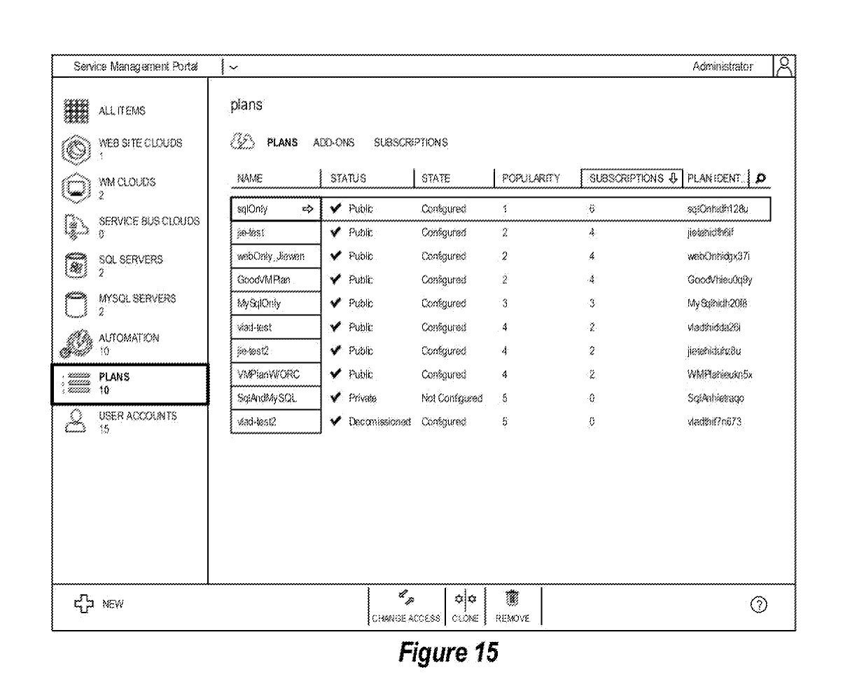

FIG. 15 illustrates various plans offered by the service provider. The plans are listed by name, status, state, popularity, number of subscriptions, plan identifier, and so forth.

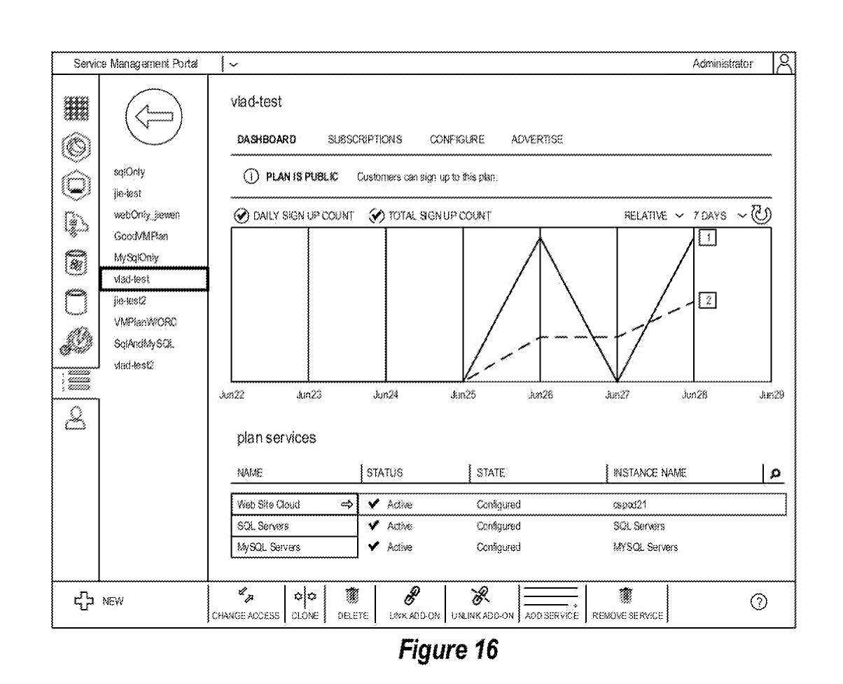

FIG. 16 illustrates a user interface provided to an administrator after narrowing in on one of the plans illustrated in FIG. 15. The user interface shows a histogram of the plan including a daily number of sign-ups for the plan, as will as a total sign-up count. The user interface also shows a name, status, state, and instance name associated with each service that supports the plan.

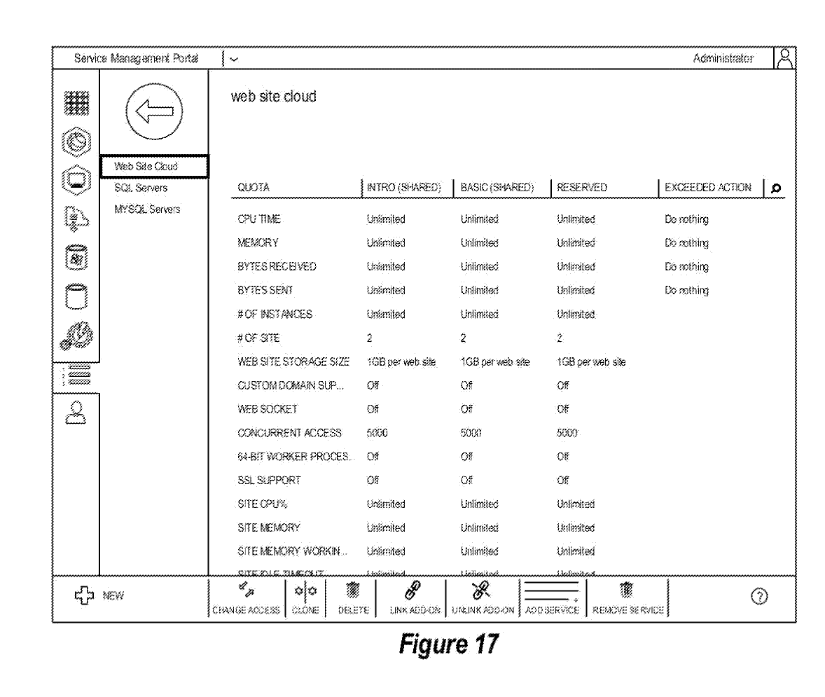

FIG. 17 illustrates a user interface showing an administrator various parameters relative to one of the services, the web site cloud.

Each of some example services will now be described in further detail beginning with a web site service, which is an example of the service 111A of FIG. 1, and the service 211A of FIG. 2. The web sites service may be a highly scalable web hosting service for public and private clouds that is especially suitable for cloud hosting economics and integrated with the prevalent OSS web apps, frameworks and tools. The web site service may create high-density, scalable website hosting services that are simple to deploy and administer, operating tens of thousands of sites in a single web farm. The web site service might perform out-of-the-box automation that lowers customer onboarding costs while resource metering and throttling can help tailor customer offerings. The web site service may support many frameworks including, for instance, ASP.NET, Classic ASP, PHP, and Node.js with full GitHub, BitBucket, DropBox and Team Foundation Server integration for source code control. Integration of the Web App Gallery allows customers access to popular web applications.

The high density solution of the web sites service may be at least partially enabled by the Dynamic Windows Process Activation Service, which centralizes web farm configuration into a database and allows for dynamic site binding and configuration. The web site service also incorporates resource metering to allow for incorporation in billing services. The web site service might also perform resource throttling which can allow for more fine grain customer offers guaranteeing capacity availability. The web site service may be a highly scalable, automated and flexible as will now be described.

As far as scalability, consider that a typical web application consists of application content stored in a file directory, one or more application databases, and configuration metadata required by the web server. This model works well for a relatively small number of web applications. The web site service allows developers and administrators to easily keep track of a handful of web applications and ensure that various external resources and supporting configuration data stay consistent.

However this model quickly becomes unwieldy as the number of web applications running in a single environment increases. There is an effective limit beyond which new web servers, file servers, and database servers are required to support increased load and increased numbers of web applications. As the number of web applications and the amount of underlying hardware and virtual machines increases, management complexity skyrockets. While a machine-centric model can be simple to administer when the number of web applications is very low (for example, numbering in the tens of applications), managing hundreds of web applications can quickly become unwieldy. If the number of web applications increases into the low thousands, even traditional command-driven management approaches optimized for bulk application management become difficult to scale and maintain. As you increase the number of web applications even further to tens of thousands of web applications running in a single virtual web farm, existing web application hosting models simply cannot scale.

At the most granular level, a cluster allocates a web application to a specific process (or processes). Instead of configuring a web server to run a given web application, a cluster configures a worker process to run a given web application. From the web application's standpoint, nothing has changed. The web application still has read and write file access to its content directories in addition to database access to required database servers. Furthermore, nothing changes in the web application's code in that all of the standard APIs that developers use to gain access to external resources such as files and databases continue to work as expected.

The worker process responsible for running the web application is supplied with all of the standard configuration files required by web applications. For example, settings specific to Internet Information Services are available in an applicationHost.config file that is accessible to the worker process. Similarly, technology-specific settings (such as ASP.NET or PHP) are available from files such as root web.config and php.ini.

Both the web application and the worker process are unaware that they are running on a cluster as opposed to a traditional Internet Information Services web server.

As far as automation is consider, the Management Portal may be used to scale websites, and to specify whether they can run in a shared website mode or reserved website mode. When a website is first created it may run in Shared mode, meaning that it shares available compute resources with other subscribers that are also running websites in Shared mode. A single instance of a website configured to run in Shared mode will provide somewhat limited performance when compared to other configurations but should still provide sufficient performance to complete development tasks or proof of concept work. If a web site that is configured to run in a single instance using Shared web site mode is put into production, the resources available to the web site may prove to be inadequate as the average number of client requests increases over time. If the CPU time quota is exceeded for the web site, all web sites in the same subscription might be stopped at some point. The web sites may then be started again at the next quota interval.

Before putting a website into production, the load that the website will be expected to handle is estimated. Based on this estimation, a decision is made on whether to consider scaling up or scaling out the website by changing configuration options available on the website's Scale management page available in the web site service.

A web site that is configured as or updated to Shared mode uses a low-cost scaling mode that provides more performance than free mode. Changing to Shared mode is easily done in the Scale tab of the management portal. These changes take only seconds to apply, and do not require code to be changed or the application to be redeployed. A web site in Shared mode is deployed in the same multi-tenant environment as one in free mode, but has no quotas or upper limit to the amount of bandwidth it can serve. A web site running in Shared mode also supports the ability to receive mapping for multiple custom DNS domain names, using both CNAME and A-records. Using A-records allows web sites to be accessed using only the domain name.

When a website's mode is changed from Shared to Reserved, the website is scaled up to run on a single dedicated core with access to additional memory, disk space and bandwidth. A web site that is configured as Reserved will provide more consistent performance than a web site that is configured as Free or Shared. When a web site is configured as Reserved, the size of the web site is specified (e.g., Small, Medium or Large). A web site that is configured with a larger Reserved Instance Size will perform better under load. The value for Reserved Instance Count (e.g., from 1 to 3) may also be specified. Increasing the value for Reserved Instance Count will provide fault tolerance and improved performance through scale out.

As far as flexibility, the web site service can quickly create and deploy a web application created from a web gallery that makes available a wide range of web application developed by any entity. The web site service may also deploy web sites from remote computers using, for example, WebDeploy, FTP, WebDeploy, GIT, BitBucket, DropBox or Team Foundation Server.

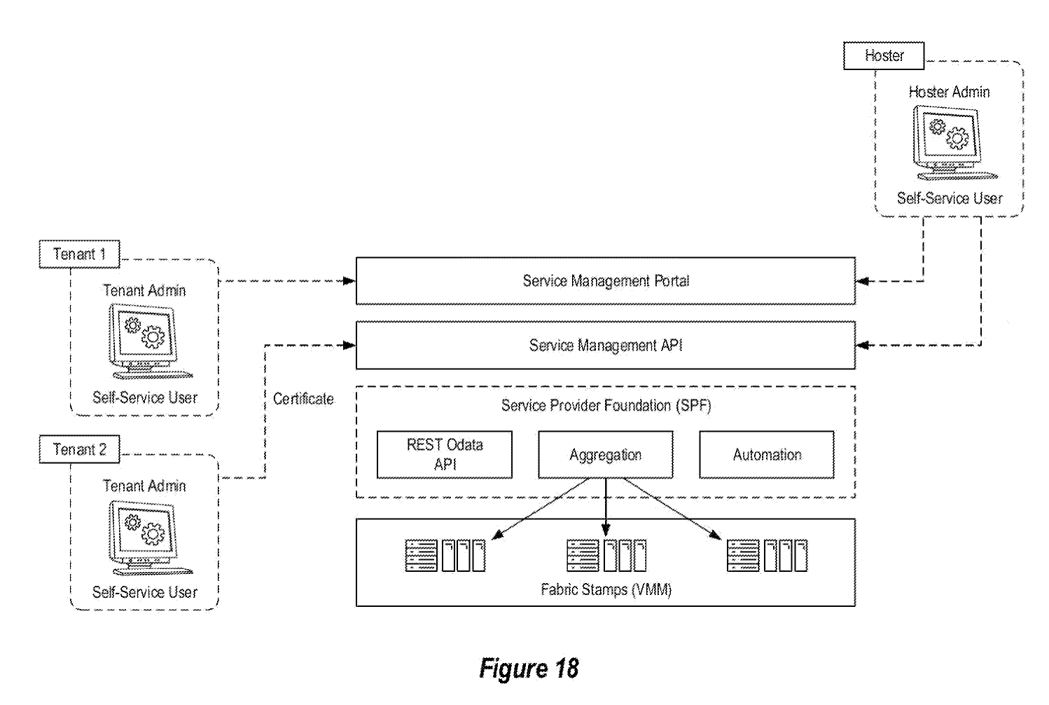

In one example, the service 111B and the service 211B are examples of a virtual machine service. In some embodiments, the virtual machine service creates an Infrastructure as a Service solution. To deploy an IaaS solution you start with a Fabric stamps, these each are managed by a VMM server. FIG. 18 illustrates an environment in which there are 3 stamps and 3 VMM servers. The Service Provider Foundation provides a REST OData API, aggregates across VMM server stamps, and can be extended with automation that works with other systems. Note how a hoster can interface with the service management portal (a user interface) as well as a service management API (for programmatic accesses). Likewise, various tenants may access the service management portal the have programmatic access via the service management API.

As with all of the other services, the virtual machine service is compatible with all of the operating systems 221, 222 and 223, and provides the same consistent experience via the management portal/API 201. Thus, the same as in public clouds, hosters and enterprises can offer both customized service offerings as well as standardized parameter for tenants. The virtual machine service offers customers the ability to choose from a library of virtual machines, providing the ability to create your own custom virtual machine templates and store them in a library and select which ones are available to which tenant.

Access to virtual machines goes through the Service Management API 210. This API layer allows access via two methods. The Service Management Portal can be accessed by multiple tenants whose resources are isolated from each other. Tenants can also access VMs programmatically or via CLI through the API by presenting a certificate.

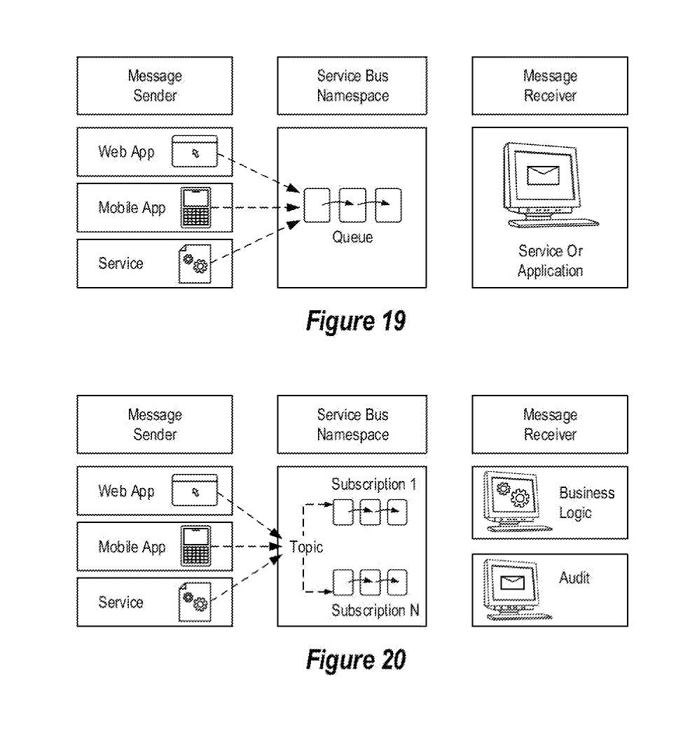

The service 111C and the service 211C are examples of a service bus service. Whether software runs in the cloud or on premises, the software often is to interact with other software. The service bus service might offers two solutions, described herein as service bus queues (illustrated generally in FIG. 19) and service bus topics (illustrated generally in FIG. 20).

Service bus queues provide load leveling by allowing the message receiver to process messages at its own pace. In addition, service bus queues provides load balancing by having multiple competing receivers that accept messages from the same queue.

Service bus topics and subscriptions support a publish/subscribe messaging communication model. When using topics and subscriptions, components of a distributed application do not communicate directly with each other, they instead exchange messages via a topic, which acts as an intermediary.

In contrast to service bus queues, where each message is processed by a single consumer, topics and subscriptions provide a one-to-many form of communication, using a publish/subscribe pattern. Multiple subscriptions may be registered to a topic. When a message is sent to a topic, it is then made available to each subscription to handle/process independently.

A topic subscription resembles a virtual queue that receives copies of the messages that were sent to the topic. Filter rules may be optionally registered for a topic on a per-subscription basis, which allows one to filter and/or restrict which messages to a topic are received by which topic subscriptions. Service bus topics and subscriptions enable scaling to process a very large number of messages across a very large number of users and applications.

The principles described herein may be practice in the context of a computing system, and a collection of computing systems. Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

In its most basic configuration, a computing system typically includes at least one processing unit and memory. The memory may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “executable module” or “executable component” can refer to software objects, routings, or methods that may be executed on the computing system. The different components, modules, engines, and services described herein may be implemented as objects or processes that execute on the computing system (e.g., as separate threads).

One or more processors of the associated computing system direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory of the computing system. Computing systems may also contain communication channels that allow the computing system to communicate with other message processors over, for example, a network.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other tangible medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising one or more computer-readable storage media having thereon computer-executable instructions that are structured such that, when executed by one or more processors of the computing system, cause the computing system to offer an application program interface, the application program interface comprising:
one or more interfaces through which a hoster of a cloud computing environment may facilitate any of a plurality of services within the cloud computing environment.

2. The computer program product in accordance with claim 1, the one or more interfaces including an application program interface that allows programmatic access to at least one of the first cloud computing environment or the second cloud computing environment.

3. The computer program product in accordance with claim 1, the one or more interfaces comprising one or more interfaces through which a service may be added to the cloud computing environment.

4. The computer program product in accordance with claim 1, the one or more interfaces comprising one or more interfaces through which a service may be provisioned within the cloud computing environment.

5. The computer program product in accordance with claim 1, the one or more interfaces comprising one or more interfaces through which a service may be managed within the cloud computing environment.

6. The computer program product in accordance with claim 1, the plurality of services being different services.

7. The computer program product in accordance with claim 6, the different services including at least a web site service.

8. The computer program product in accordance with claim 6, the different services including at least a virtual machine service.

9. The computer program product in accordance with claim 6, the different services including at least a service bus service.

10. The computer program product in accordance with claim 1, the one or more interfaces comprising a plan creation interface through which a hoster may create one or more plans that may be subscribed to by tenants of the cloud computing environment.

11. The computer program product in accordance with claim 10, the one or more interface further comprising one or more tenant interfaces through which a tenant may subscribe to one or more of the plans.

12. A computer program product comprising one or more computer-readable storage media having thereon computer-executable instructions that are structured such that, when executed by one or more processors of a computing system, cause the computing system to operate an interface comprising a user interface,
the user interface being structured to interface with a first cloud computing environment having a first hoster,
the user interface also being configurable to interface with a second cloud computing environment having a second hoster that is different than the first hoster.

13. The computer program product in accordance with claim 12, the first cloud computing environment being a public cloud, a hoster cloud or a private cloud.

14. The computer program product in accordance with claim 12, the interface also having an application program interface that allows programmatic access to at least one of the first cloud computing environment or the second cloud computing environment.

15. The computer program product in accordance with claim 12, wherein the user interface includes a display area for presenting visual elements comprising:
a first control component that, when selected by the administrator, allows for managing data storage or compute capacity quotas for one or more services; and
a second control component that, when selected by the administrator, allows for selecting the one or more services for aggregation into the at least one plan.

16. The computer program product in accordance with claim 12, wherein the interface also allowing for creation of a plan containing service quotas for different services.

17. The computer program product in accordance with claim 16 wherein the at least one plan is distributed to end users within a listing of plans, and wherein the listing of plans includes candidate plans of online service presented within a menu user interface.

18. The computer program product in accordance with claim 17, wherein, upon the end users registering for the at least one plan, instantiating role instances of tenants associated with the end users, respectively, on one or more of the multiple clouds.

19. The computer program product in accordance with claim 18, wherein the instantiated role instances operate according to a service level (SLA) established by the one or more aggregated services of the at least one plan.

20. A computing system comprising:
one or more processors;
one or more computer-readable storage media having thereon computer-executable instructions that are structured such that, when executed by one or more processors of a computing system, cause the computing system to operate a user interface, the user interface being structured to interface with a first cloud computing environment having a first hoster, the user interface also being configurable to interface with a second cloud computing environment having a second hoster that is different than the first hoster.

21. The computing system in accordance with claim 20, the user interface having a common set of functions that are available regardless of whether the user interface is used to interface with the first cloud computing environment or a second cloud computing environment.

22. The computing system in accordance with claim 21, the common set of functions each providing a consistent user experience regardless of whether the user interface is used to interface with the first cloud computing system or the second cloud computing environment.

23. The computing system in accordance with claim 21, one or more computer-readable storage media further having thereon computer-executable instructions that are structured such that, when executed by the one or more processors, cause the computing system to operate an application program interface that allows programmatic access to at least one of the first cloud computing environment or the second cloud computing environment.
